(19) United States
(12) Patent Application Publication
(10) Pub. No.: US 2012/0148095 A1
(43) Pub. Date: Jun. 14, 2012

(54) IMAGE PROCESSING APPARATUS

(75) Inventors: Masayoshi Okamoto, Daito-shi (JP); Jun Kiyama, Higashiosaka-shi (JP)

(73) Assignee: SANYO ELECTRIC CO., LTD., Osaka (JP)

(21) Appl. No.: 13/296,859

(22) Filed: Nov. 15, 2011

(30) Foreign Application Priority Data
Dec. 9, 2010 (JP) 2010-274198

(51) Int. Cl. G06K 9/62

(52) U.S. Cl. 382/103

(57) ABSTRACT

An image processing apparatus includes a detector. A detector detects one or at least two object images each of which is coincident with a dictionary image from each of K (K: an integer of two or more) of continuous shot images. A classifier executes on the K of continuous shot images a process of classifying the object images detected according to a common object. A determiner determines an attribute of equal to or less than K of object images belonging to each of one or at least two object image groups classified. A first excluder excludes a continuous shot image satisfying an error condition out of the K of the continuous shot images, based on a determined result. A selector selects a part of one or at least two continuous shot images remained after an exclusion as a specific image.

### CROSS REFERENCE OF RELATED APPLICATION

The disclosure of Japanese Patent Application No. 2010-274198, which was filed on Dec. 9, 2010, is incorporated here by reference.

### BACKGROUND OF THE INVENTION

1. Field of the Invention

The present invention relates to an image processing apparatus. More particularly, the present invention relates to an image processing apparatus which is applied to an electronic camera and selects any one of a plurality of continuous shot images as a recorded continuous shot image.

2. Description of the Related Art

According to one example of this type of apparatus, face recognition parameters such as a smile degree, a position of a face, a tilt of the face and a gender are detected for each of a plurality of persons appeared in a frame. A photographing control such as a timing-determination to release a shutter and a self-timer control are executed based on a mutual relationship of the detected face recognition parameters. Specifically, a closeness degree of the person is calculated based on an interval between the faces, the smile degree of each face and the tilt of each face, and the photographing control is activated when the calculated closeness degree has been exceeded a threshold value.

However, in the above-described apparatus, the photographing control is not activated unless the closeness degree exceeds the threshold value, and therefore, an image selecting performance is limited.

### SUMMARY OF THE INVENTION

An image processing apparatus according to the present invention, comprises: a detector which detects one or at least two object images each of which is coincident with a dictionary image from each of K (K: an integer of two or more) of continuous shot images; a classifier which executes on the K of continuous shot images a process of classifying the object images detected by the detector according to a common object; a determiner which determines an attribute of equal to or less than K of object images belonging to each of one or at least two object image groups classified by the classifier; a first excluder which excludes a continuous shot image satisfying an error condition out of the K of the continuous shot images, based on a determined result of the determiner; and a selector which selects a part of one or at least two continuous shot images remained after an exclusion of the first excluder as a specific image.

According to the present invention, a computer program embodied in a tangible medium, which is executed by a processor of an image processing apparatus, the program comprises: a detecting step of detecting one or at least two object images each of which is coincident with a dictionary image from each of K (K: an integer of two or more) of continuous shot images; a classifying step of executing on the K of continuous shot images a process of classifying the object images detected by the detecting step according to a common object; a determining step of determining an attribute of equal to or less than K of object images belonging to each of one or at least two object image groups classified by the classifying step; a first excluding step of excluding a continuous shot image satisfying an error condition out of the K of the continuous shot images, based on a determined result of the determining step; and a selecting step of selecting a part of one or at least two continuous shot images remained after an exclusion of the first excluding step as a specific image.

According to the present invention, an image processing method executed by an image processing apparatus, comprises: a detecting step of detecting one or at least two object images each of which is coincident with a dictionary image from each of K (K: an integer of two or more) of continuous shot images; a classifying step of executing on the K of continuous shot images a process of classifying the object images detected by the detecting step according to a common object; a determining step of determining an attribute of equal to or less than K of object images belonging to each of one or at least two object image groups classified by the classifying step; a first excluding step of excluding a continuous shot image satisfying an error condition out of the K of the continuous shot images, based on a determined result of the determining step; and a selecting step of selecting a part of one or at least two continuous shot images remained after an exclusion of the first excluding step as a specific image.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an allocation state of an evaluation area in an imaging surface;

FIG. 4 is an illustrative view showing one example of a face frame structure used in a face detection process;

FIG. 5 is an illustrative view showing one example of a configuration of a face dictionary referred to in the face detection process;

FIG. 6 is an illustrative view showing one portion of the face detection process;

FIG. 7 is an illustrative view showing one example of a configuration of a register applied to the embodiment in FIG. 2;

FIG. 8 is an illustrative view showing one example of a configuration of another register applied to the embodiment in FIG. 2;

FIG. 9 (A) is an illustrative view showing one example of image data of a first frame;

FIG. 9 (B) is an illustrative view showing one example of image data of a second frame;

FIG. 10 (A) is an illustrative view showing one example of image data of a third frame;

FIG. 10 (B) is an illustrative view showing one example of image data of a fourth frame;

FIG. 11 is an illustrative view showing one portion of behavior of the embodiment in FIG. 2;

FIG. 12 is an illustrative view showing another portion of behavior of the embodiment in FIG. 2;

FIG. 13 is a flowchart showing one portion of behavior of a CPU applied to the embodiment in FIG. 2;

FIG. 14 is a flowchart showing another portion of behavior of the CPU applied to the embodiment in FIG. 2;

FIG. 15 is a flowchart showing still another portion of behavior of the CPU applied to the embodiment in FIG. 2;

FIG. 16 is a flowchart showing yet another portion of behavior of the CPU applied to the embodiment in FIG. 2;

FIG. 17 is a flowchart showing another portion of behavior of the CPU applied to the embodiment in FIG. 2;

FIG. 18 is a flowchart showing still another portion of behavior of the CPU applied to the embodiment in FIG. 2;

FIG. 19 is a flowchart showing yet another portion of behavior of the CPU applied to the embodiment in FIG. 2;

FIG. 20 is a flowchart showing another portion of behavior of the CPU applied to the embodiment in FIG. 2;

FIG. 21 is a flowchart showing still another portion of behavior of the CPU applied to the embodiment in FIG. 2; and

FIG. 22 is a block diagram showing a configuration of another embodiment of the present invention.

### DETAILED DESCRIPTION OF THE PREFERRED EMBODIMENTS

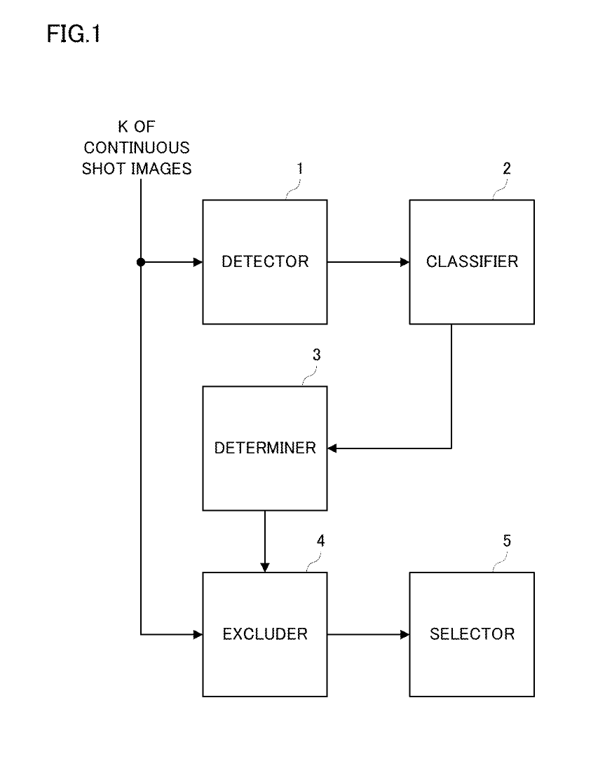

With reference to FIG. 1, an image processing apparatus according to one embodiment of the present invention is basically configured as follows: A detector 1 detects one or at least two object images each of which is coincident with a dictionary image from each of K (K: an integer of two or more) of continuous shot images. A classifier 2 executes on the K of continuous shot images a process of classifying the object images detected by the detector 1 according to a common object A determiner 3 determines an attribute of equal to or less than K of object images belonging to each of one or at least two object image groups classified by the classifier 2. A first excluder 4 excludes a continuous shot image satisfying an error condition out of the K of the continuous shot images, based on a determined result of the determiner 3. A selector 5 selects a part of one or at least two continuous shot images remained after an exclusion of the first excluder 4 as a specific image.

When a posture of an object is varied in a process of a continuous shooting, the number of the object images forming the object image group varies in a range of equal to or less than K. Thus, by noticing the attribute of the equal to or less than K of the object images belonging to each object image group, it becomes possible to comprehend a quality of the object image appeared in each of the K of the continuous shot images, and furthermore, it becomes possible to exclude the continuous shot image in which a low-quality object image is appeared. The specific image is selected from among the one or at least two continuous shot images remained after thus excluded. Thereby, an image selecting performance is improved.

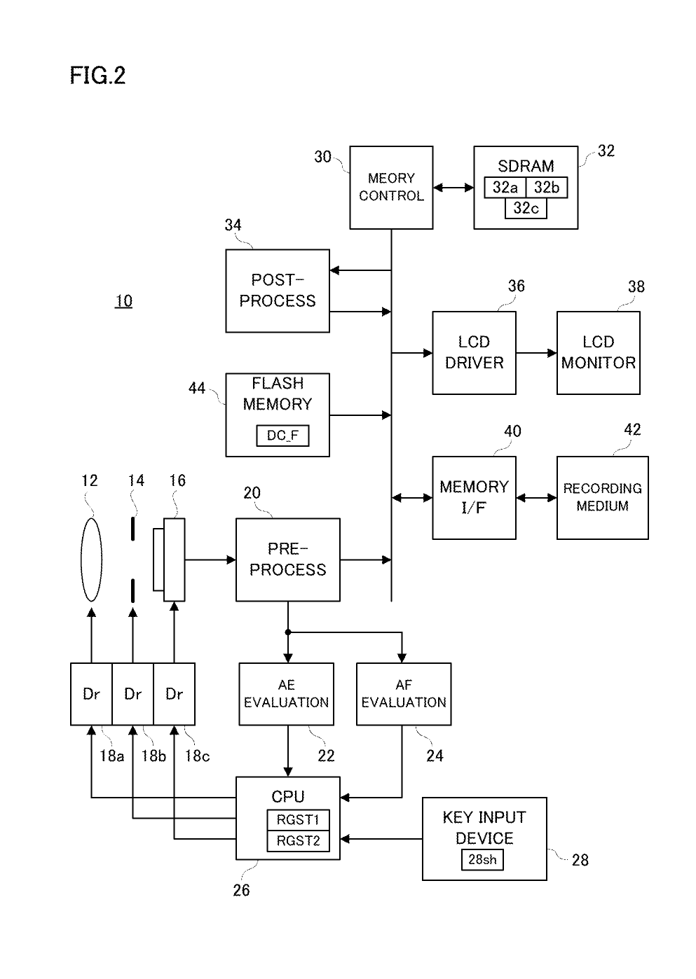

With reference to FIG. 2, a digital camera 10 according to one embodiment includes a zoom lens 12 and an aperture unit 14 driven by drivers 18a and 18b respectively. An optical image of a scene that underwent these components enters, with irradiation, an imaging surface of an imager 16, and is subjected to a photoelectric conversion. Thereby, electric charges representing a scene image are produced.

When a power source is applied, in order to execute a moving-image taking process, a CPU 26 commands a driver 18c to repeat an exposure procedure and an electric-charge reading-out procedure under the imaging task. In response to a vertical synchronization signal Vsync periodically generated from an SG (Signal Generator) not shown, the driver 18c exposes the imaging surface and reads out the electric charges produced on the imaging surface in a raster scanning manner. From the imager 16, raw image data that is based on the read-out electric charges is cyclically outputted.

A pre-processing circuit 20 performs processes, such as digital clamp, pixel defect correction, gain control and etc., on the raw image data outputted from the imager 16. The raw image data on which these processes are performed is written into a raw image area 32a of an SDRAM 32 through a memory control circuit 30.

A post-processing circuit 34 reads out the raw image data accommodated in the raw image area 32a through the memory control circuit 30, and performs a color separation process, a white balance adjusting process and a YUV converting process, on the read-out raw image data. YUV formatted-image data generated thereby is written into a YUV image area 32b of the SDRAM 32 by the memory control circuit 30.

An LCD driver 36 repeatedly reads out the image data accommodated in the YUV image area 32b through the memory control circuit 30, and drives an LCD monitor 38 based on the read-out image data. As a result, a real-time moving image (a live view image) of the scene is displayed on a monitor screen.

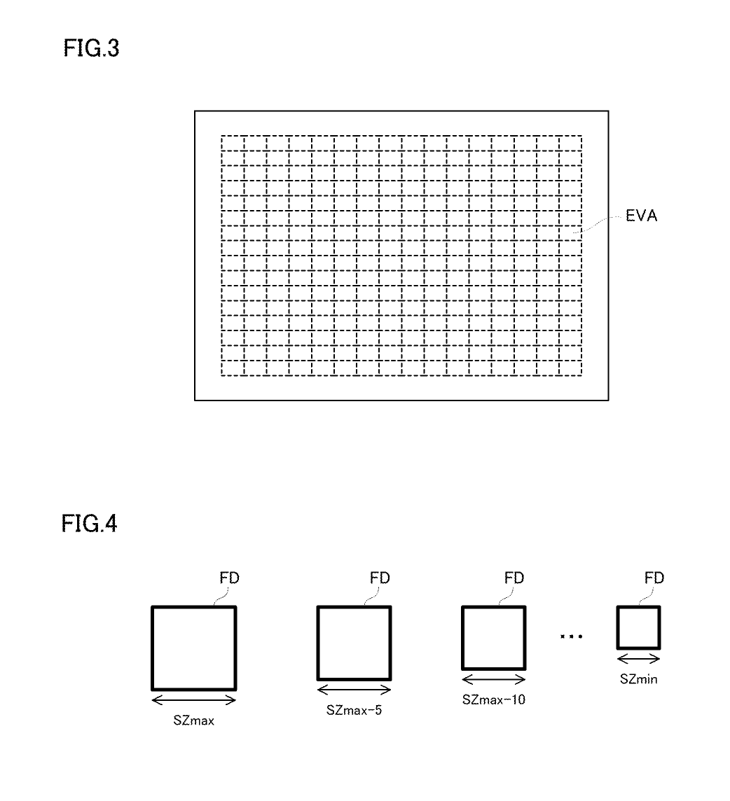

With reference to FIG. 3, an evaluation area EVA is allocated to a center of the imaging surface. The evaluation area EVA is divided into 16 portions in each of a horizontal direction and a vertical direction; therefore, 256 divided areas form the evaluation area EVA. Moreover, in addition to the above-described processes, the pre-processing circuit 20 shown in FIG. 2 executes a simple RGB converting process which simply converts the raw image data into RGB data.

An AE evaluating circuit 22 integrates RGB data belonging to the evaluation area EVA, out of the RGB data produced by the pre-processing circuit 20, at every time the vertical synchronization signal Vsync is generated. Thereby, 256 integral values (256 AE evaluation values) are outputted from the AE evaluating circuit 22 in response to the vertical synchronization signal Vsync. An AF evaluating circuit 24 integrates a high-frequency component of the RGB data belonging to the evaluation area EVA, out of the RGB data generated by the pre-processing circuit 20, at every time the vertical synchronization signal Vsync is generated. Thereby, 256 integral values (256 AF evaluation values) are outputted from the AF evaluating circuit 24 in response to the vertical synchronization signal Vsync.

When a shutter button 28sh arranged in a key input device 28 is in a non-operated state, the CPU 26 executes a simple AE process based on the 256 AE evaluation values outputted from the AE evaluating circuit 22 so as to calculate an appropriate EV value. An aperture amount and an exposure time period that define the calculated appropriate EV value are set to the drivers 18b and 18c, and thereby, a brightness of the live view image is adjusted roughly.

When the shutter button 28sh is half depressed, the CPU 26 executes a strict AE process with reference to the AE evaluating values so as to calculate an optimal EV value. An aperture amount and an exposure time period that define the calculated optimal EV value are set to the drivers 18b and 18c, respectively, and thereby, the brightness of the live view image is adjusted strictly. Moreover, the CPU 26 executes an AF process based on the 256 AF evaluating values outputted from the AF evaluating circuit 24. The focus lens 12 is moved in an optical-axis direction by the driver 18a to search for a focal point, and is placed at the focal point discovered thereby. As a result, a sharpness of the live view image is improved.

A shooting mode is switched by a mode selector switch 28md between a single shooting mode and a continuous shooting mode. Moreover, in the continuous shooting mode, it is possible to turn on/off a best shot selecting function.

When the shutter button 28sh is fully depressed in a state where the single shooting mode is selected, the CPU 26 executes a still-image taking process only once. As a result, one frame of the image data representing the scene at a time point at which the shutter button 28sh is fully depressed is evacuated to a recording image area 32c. Upon completion of the still-image taking process, the CPU 26 commands a memory I/F 40 to execute a recording process on the one frame of the image data evacuated to the recording image area 32c. The memory I/F 40 reads out the designated image data from the recording image area 32c through the memory control circuit 30 so as to record the read-out image data in a file format on a recording medium 42.

When the shutter button 28sh is frilly depressed in a state where the continuous shooting mode, a total of four still-image taking processes are executed at every time the vertical synchronization signal Vsync is generated. As a result, successive four frames of the image data are evacuated to the recording image area 32c.

When the best shot selecting function is in an off-state, the CPU 26 commands the memory I/F 40 to execute the recording process on all of the evacuated four frames of the image data. On the other hand, when the best shot selecting function is in an on-state, the CPU 26 commands the memory I/F 40 to execute the recording process on any one of the evacuated four frames of the image data. Similarly to the above-described case, the memory I/F 40 reads out the designated image data from the recording image area 32c through the memory control circuit 30 so as to record the read-out image data in the file format on the recording medium 42.

When the best shot selecting function is in the on-state, following processes are executed by the CPU 26.

Firstly, a variable K is set to each of “1” to “4” so as to resize image data of a K-th frame evacuated to the recording image area 32c. Thereby, two frames of the image data respectively having a QVGA resolution and an XGA resolution are additionally created corresponding to the K-th frame. Subsequently a face detection process is performed on the QVGA resolution image data.

In the face detection process, used are a face frame structure FD of which size is adjusted as shown in FIG. 4 and a face dictionary DC_F containing three dictionary images (=face images of which directions are mutually different) shown in FIG. 5. As can be seen from FIG. 5, a face dictionary number FDIC and a face direction are allocated to each of the three dictionary images. Moreover, the face dictionary DC_F is stored in a flash memory 44.

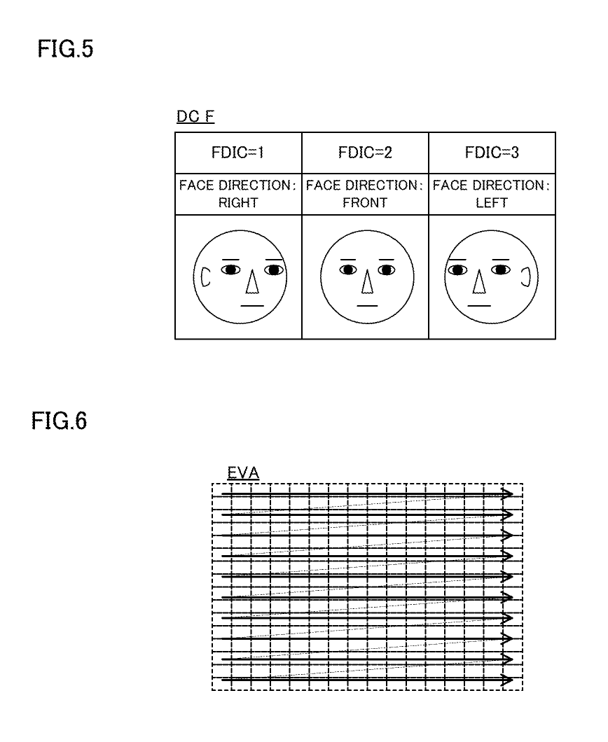

A search area is set so as to cover the whole evaluation area EVA shown in FIG. 3. Moreover, in order to define a variable range of the size of the face frame structure FD, a maximum size SZmax is set to “200”, and a minimum size SZmin is set to “20”. The face frame structure FD is moved by each predetermined amount in the raster scanning manner, from a start position (an upper left position) toward an ending position (a lower right position) of the search area (see FIG. 6). Moreover, the size of the face frame structure FD is reduced by a scale of “5” from “SZmax” to “SZmin” at every time the face frame structure FD reaches the ending position.

Apart of the image data belonging to the face frame structure FD is extracted from the image data of the K-th frame having the QVGA resolution. A characteristic amount of the extracted image data is compared with each of characteristic amounts of the three dictionary images contained in the face dictionary DC_F. When a matching degree equal to or more than a threshold value TH is obtained, it is regarded that the face image has been detected.

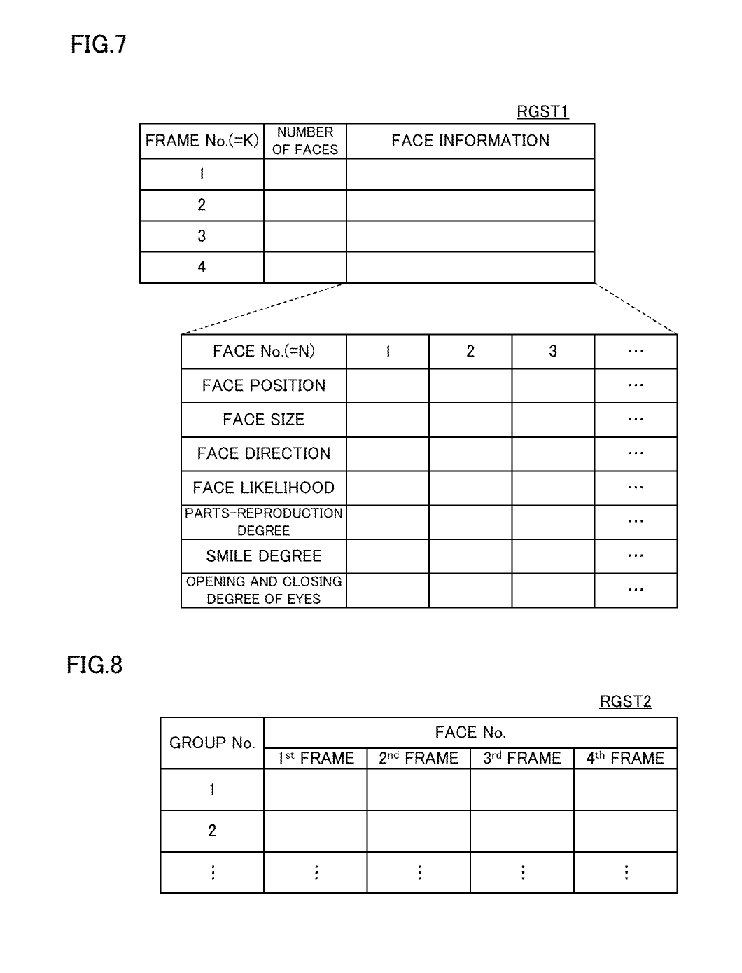

At this time, a position and a size of the face frame structure FD at a current time point and a face direction allocated to a dictionary image of a matching direction are registered in a K-th large column arranged in a register RGST1 shown in FIG. 7 as a part of face information. Moreover, a face likelihood of the image data belonging to the face frame structure FD is calculated based on the above-described matching degree. The calculated face likelihood is also registered in the K-th large column of the register RGST1 as another part of the face information. Furthermore, the number of the faces described in the K-th large column of the register RGST1 is incremented along with these registration processes.

As shown in FIG. 7, each of the large columns arranged in the register RGST1 has a plurality of small columns respectively corresponding to a plurality of face numbers. Moreover, a variable N equivalent to the face number is incremented at every time the face image is detected. Thus, face information corresponding to an N-th face image detected from the image data of the K-th frame is described in an N-th small column forming the K-th large column.

When the number of the faces described in the K-th column of the register RGST1 indicates equal to or more than “1”, the variable N is set to each of “1” to “Nmax” (Nmax: the number of the faces) so as to specify the N-th face image on the XGA resolution image data corresponding to the K-th frame. Upon specifying the face image, a face position and a face size described in the N-th small column forming the K-th large column are referred to.

Subsequently, a reproduction degree of parts forming the specified face image (parts: eye, nose and mouth), a smile degree of the specified face image and an opening and closing degree of the eyes on the specified face image are calculated. The calculated parts-reproduction degree, smile degree and opening and closing degree are registered in the N-th small column forming the K-th large column as another part of the face information.

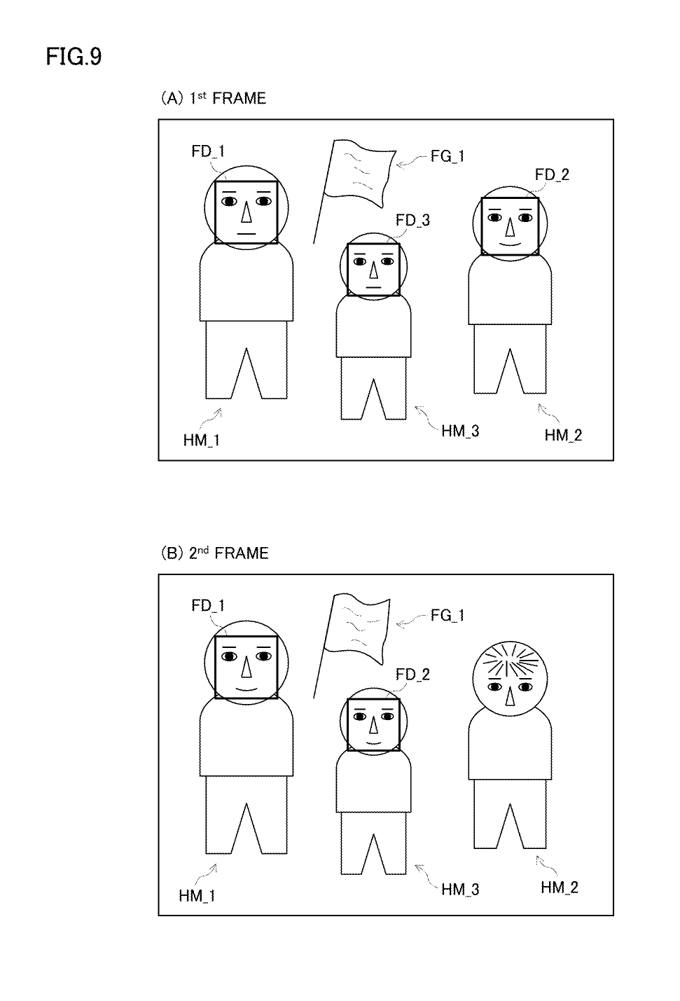

Thus, when persons HM_1 to HM_3 and a flag FG_1 are appeared in image data of a first frame as shown in FIG. 9 (A), the first face image is detected corresponding to a face frame structure FD_1 surrounding a face image of the person HM_1, the second face image is detected corresponding to a face frame structure FD_2 surrounding a face image of the person HM_2, and the third face image is detected corresponding to a face frame structure FD_3 surrounding a face image of the person HM_3.

In the first large column of the register RGST1, face information corresponding to the face image of the person HM_1 is registered on the first small column, face information corresponding to the face image of the person HM_2 is registered on the second small column, and face information corresponding to the face image of the person HM_3 is registered on the third small column.

Moreover, when the persons HM_1 to HM_3 and the flag FG_1 are appeared in image data of the second frame as shown in FIG. 9 (B), the first face image is detected corresponding to the face frame structure FD_1 surrounding the face image of the person HM_1, and the second face image is detected corresponding to the face frame structure FD_2 surrounding the face image of the person HM_3. In the second large column of the register RGST1, the face information corresponding to the face image of the person HM_1 is registered on the first small column, and the face information corresponding to the face image of the person HM_3 is registered on the second small column.

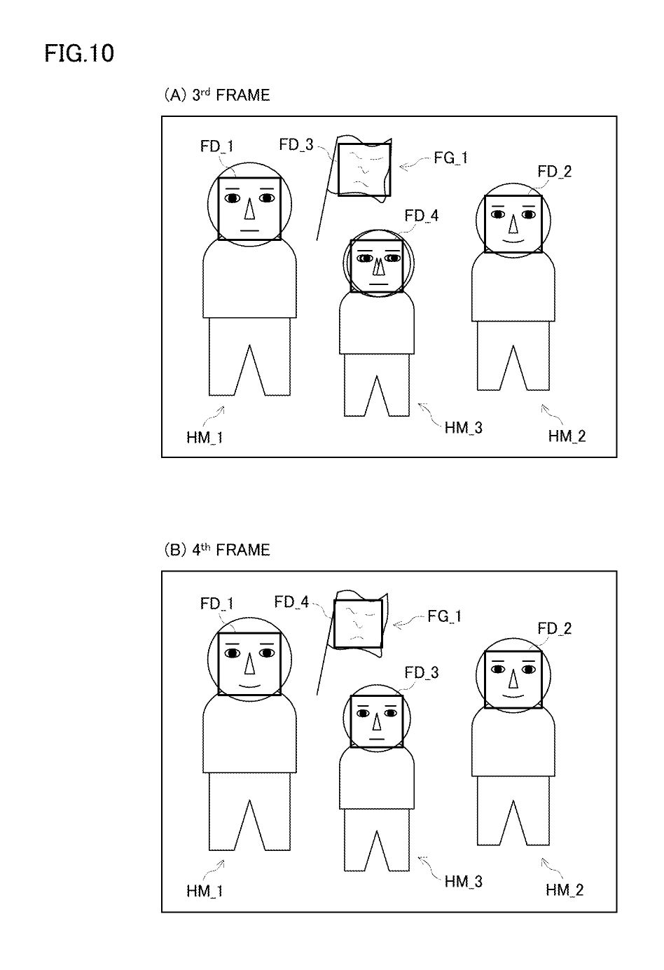

Furthermore, when the persons HM_1 to HM_3 and the flag FG_1 are appeared in image data of the third frame as shown in FIG. 10 (A), the first face image is detected corresponding to the face frame structure FD_1 surrounding the face image of the person HM_1, and the second face image is detected corresponding to the face frame structure FD_2 surrounding the face image of the person HM_2. Moreover, the third face image is erroneously detected corresponding to the face frame structure FD_3 surrounding creases appeared in the flag FG_1, and the fourth face image is detected corresponding to a face frame structure FD_4 surrounding the face image of the person HM_3.

In the third large column of the register RGST1, the face information corresponding to the face image of the person HM_1 is registered on the first small column, and the face information corresponding to the face image of the person HM_2 is registered on the second small column. Moreover, face information erroneously created corresponding to the creases of the flag FG_1 is registered on the third small column, and the face information corresponding to the face image of the person HM_3 is registered on the fourth small column.

Moreover, when the persons HM_1 to HM_3 and the flag FG_1 are appeared in image data of the fourth frame as shown in FIG. 10 (B), the first face image is detected corresponding to the face frame structure FD_1 surrounding the face image of the person HM_1, and the second face image is detected corresponding to the face frame structure FD_2 surrounding the face image of the person HM_2. Moreover, the third face image is detected corresponding to the face frame structure FD_3 surrounding the face image of the person HM_3, and the fourth face image is erroneously detected corresponding to the face frame structure FD_4 surrounding the creases appeared in the flag FG_1.

In the fourth large column of the register RGST1, the face information corresponding to the face image of the person HM_1 is registered on the first small column, and the face information corresponding to the face image of the person HM_2 is registered on the second small column. Moreover, the face information corresponding to the face image of the person HM_3 is registered on the third small column, and the face information erroneously created corresponding to the creases of the flag FG_1 is registered on the fourth small column.

Upon completion of the above-described processes performed on the four frames of the image data evacuated to the recording image area 32c, the face images appeared in these image data are converted into a group for each common face. Upon converting into the group, the size and position of the face image described in the register RGST1 are referred to. As a result, one or at least two groups each of which is formed of equal to or less than four face images are constructed. A face number identifying the face image in each constructed group is described in a register RGST2 shown in FIG. 8.

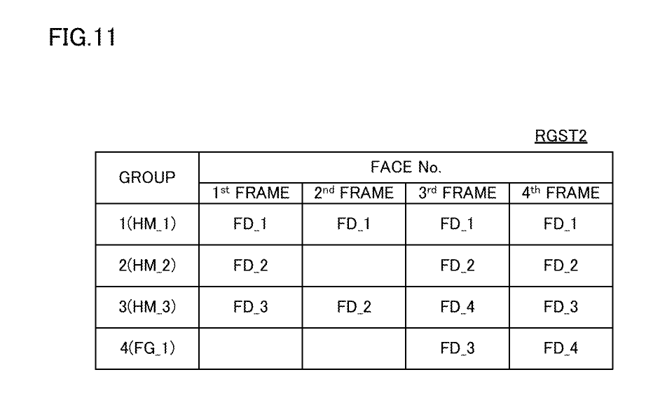

In an example shown in FIG. 9 (A) to FIG. 10 (B), the face image of the person HM_1 is classified into the first group, the face image of the person HM_2 is classified into the second group, the face image of the person HM3 is classified into the third group, and the face image erroneously detected from the flag FG_1 is classified into the fourth group (see FIG. 11).

According to FIG. 11, a face number (=1) corresponding to the face frame structure FD_1 shown in FIG. 9 (A), a face number (=1) corresponding to the face frame structure FD_1 shown in FIG. 9 (B), a face number (=1) corresponding to the face frame structure FD_1 shown in FIG. 10 (A) and a face number (=1) corresponding to the face frame structure FD_1 shown in FIG. 10 (B) are registered on the register RGST2 corresponding to the first group. Moreover, a face number (=2) corresponding to the face frame structure FD_2 shown in FIG. 9 (A), a face number (=2) corresponding to the face frame structure FD_2 shown in FIG. 10 (A) and a face number (=2) corresponding to the face frame structure FD_2 shown in FIG. 10 (B) are registered on the register RGST2 corresponding to the second group.

Furthermore, a face number (=3) corresponding to the face frame structure FD_3 shown in FIG. 9 (A), a face number (=2) corresponding to the face frame structure FD_2 shown in FIG. 10 (A), a face number (=4) corresponding to the face frame structure FD_4 shown in FIG. 10 (A) and a face number (=3) corresponding to the face frame structure FD_3 shown in FIG. 10 (B) are registered on the register RGST2 corresponding to the third group. Moreover, a face number (=3) corresponding to the face frame structure FD_3 shown in FIG. 10 (A) and a face number (=4) corresponding to the face frame structure FD_4 shown in FIG. 10 (B) are registered on the register RGST2 corresponding to the fourth group.

Subsequently a group in which the number of the belonging face images falls below “4” is searched from among one or at least two groups registered in the register RGST2. When a desired group is discovered, a variable G equivalent to a group number is set to each of “1” to “Gmax1” (Gmax1: the total number of the discovered groups), and the G-th group is designated to determine an erroneous detection of the face image out of the one or at least two discovered groups.

One or at least two parts-reproduction degrees respectively corresponding to one or least two face images belonging to the designated group are read out from the register RGST1. An average value of the read-out one or at least two parts-reproduction degrees is compared with a reference value REF1. When the average value is equal to or less than the reference value 1, the designated group is regarded as a group constructed by the erroneous detection of the face image. A registration related to the designated group is deleted or excluded from the register RGST2 in response to determining the erroneous detection.

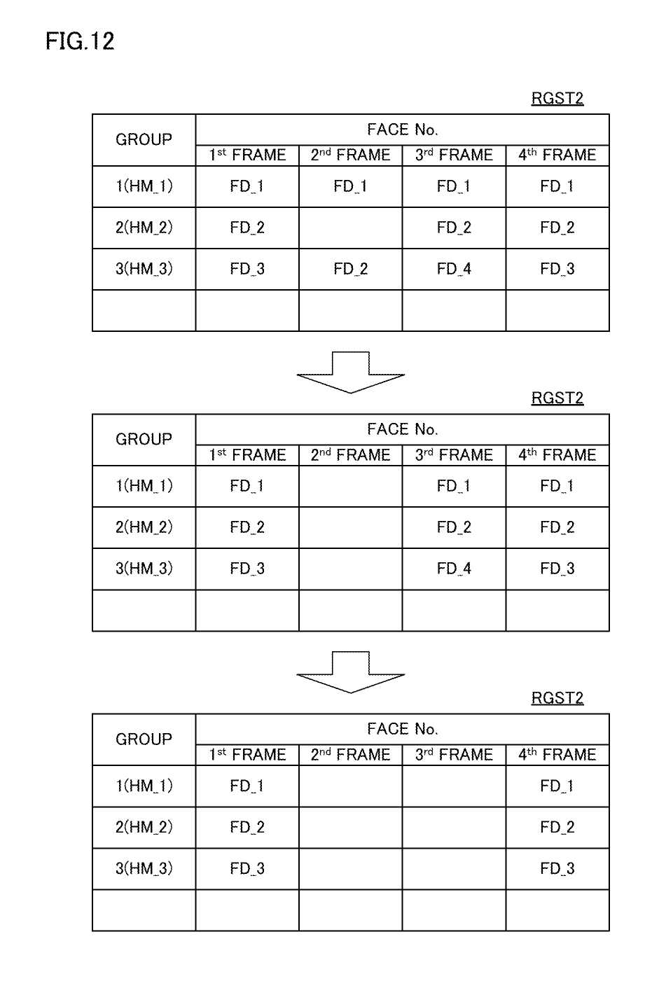

In the example shown in FIG. 9 (A) to FIG. 10 (B), the second to fourth groups on the register RGST2 are targets for an erroneous-detection determining process, and a registration regarding the fourth group is deleted or excluded from the register RGST2 (see upper level of FIG. 12).

Upon completion of the above-described excluding process on the group equivalent to “Gmax1”, in order to exclude a frame satisfying an error condition, the variable G is set to each of “1” to “Gmax2” (Gmax2: the total number of groups remained in the register RGST2). Here, the error condition has a first condition under which the face image belonging to the G-th group is missing and a second condition under which the parts-reproduction degree of the face image belonging to the G-th group falls below a reference value REF2 (REF2>REF1).

In association with the first condition, a frame in which the face image belonging to the G-th group has appeared is specified from among the four frames to be noticed. A frame which is not specified here is regarded as a frame satisfying the first condition, i.e., a missing frame, and therefore, a registration related to the missing frame is deleted or excluded from the register RGST2.

In association with the second condition, the face image in which the parts-reproduction degree falls below the reference value REF2 is searched from the G-th group. When a desired face image is discovered, a frame in which the discovered face image has appeared is regarded as a frame satisfying the second condition, and therefore, a registration related to the frame is deleted or excluded from the register RGST2.

In the example shown in FIG. 9 (A) to FIG. 10 (B), the face image of the person HM_2 belonging to the second group on the register RGST2 is not detected on the image data of the second frame. Thus, the second frame is regarded as the frame satisfying the first condition, and therefore, a registration related to the second frame is deleted or excluded from the register RGST2 (see middle level of FIG. 12).

Moreover, a parts-reproduction degree of the face image of the person HM_3 belonging to the third group on the register RGST2 falls below the reference REF2 in the fourth frame. Thus, the fourth frame is regarded as the frame satisfying the second condition, and therefore, a registration related to the fourth frame is deleted or excluded from the register RGST2 (see lower level of FIG. 12).

Upon completion of the above-described excluding process on the groups equivalent to “Gmax2”, thereafter, the number of the frames remained in the register RGST2 is detected as the number of remaining frames RE.

When the detected number of the remaining frames RF is “0”, the memory I/F 40 is commanded to execute the recording process on image data of a head frame out of four frames to be noticed. Moreover, when the number of the remaining frames RF is “1”, the CPU 26 commands the memory I/F 40 to execute the recording process on image data of the remaining frame.

When the remaining frames RF exceeds “1”, qualities of one or at least two face images appeared in the remaining frames are evaluated for each frame. Upon evaluation, the face direction, the face likelihood, the smile degree and the opening and closing degree of the eyes described in the register RGST1 are referred to. Then, a simple frame which is most highly evaluated is selected from among the remaining frames. Upon completion of a selecting process, the memory I/F 40 is commanded to execute the recording process on image data of the selected frame.

The memory I/F 40 reads out the designated image data from the recording image area 32c through the memory control circuit 30 so as to record the read-out image data in the file format on the recording medium 42.

In the example shown in FIG. 9 (A) to FIG. 10 (B), as shown in the lower level of FIG. 12, the first frame and the fourth frame are regarded as the remaining frames. Thus, qualities of the face images of the persons HM_1 to HM_3 appeared in the first frame are evaluated, and concurrently, qualities of the face images of the persons HM_1 to HM_3 appeared in the fourth frame are evaluated. As a result, when the fourth frame is highly evaluated, the image data of the fourth frame is recorded on the recording medium 42.

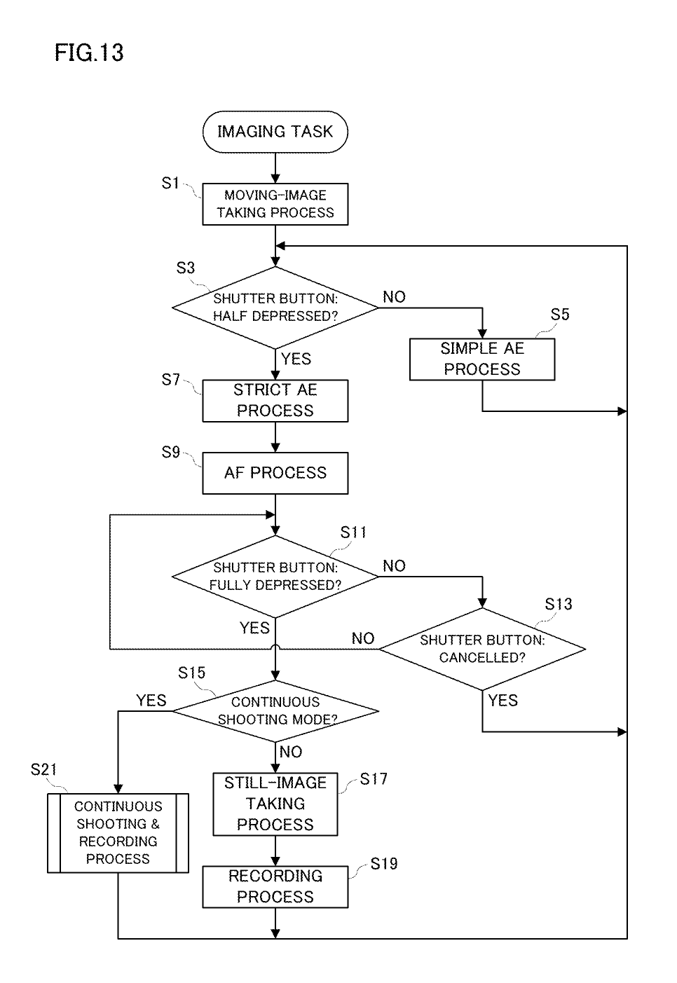

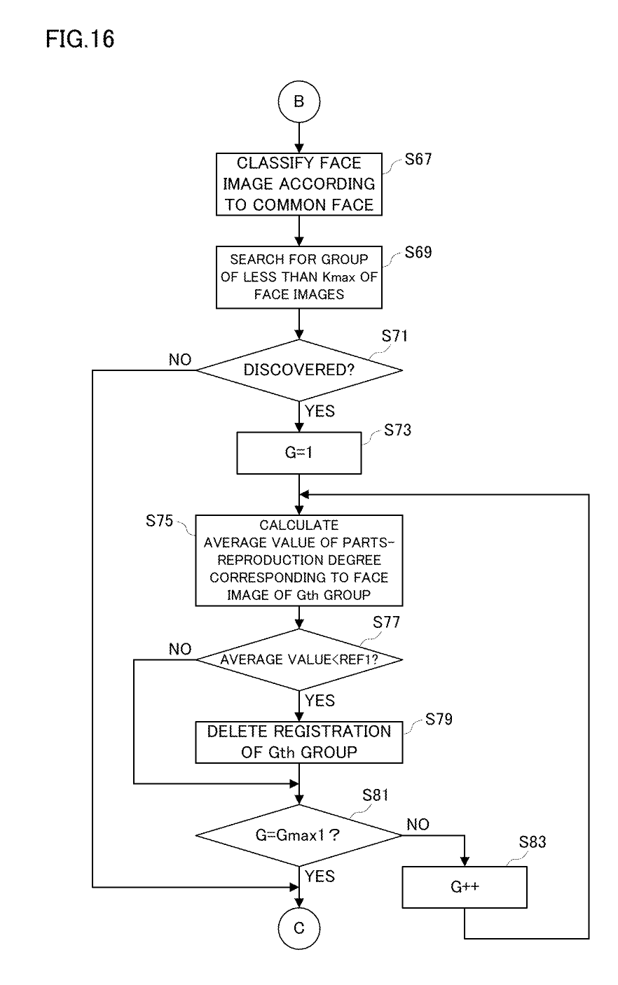

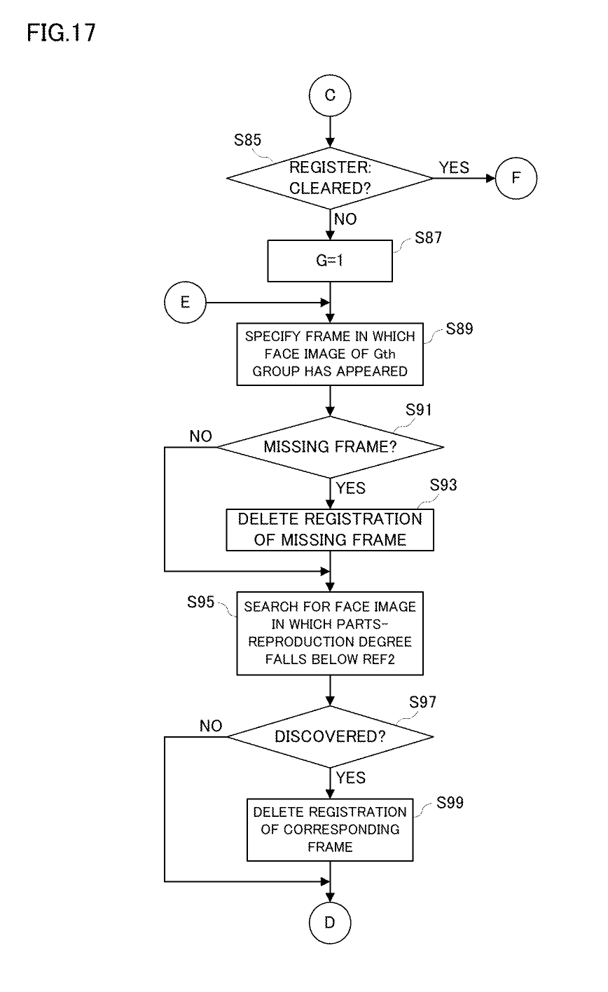

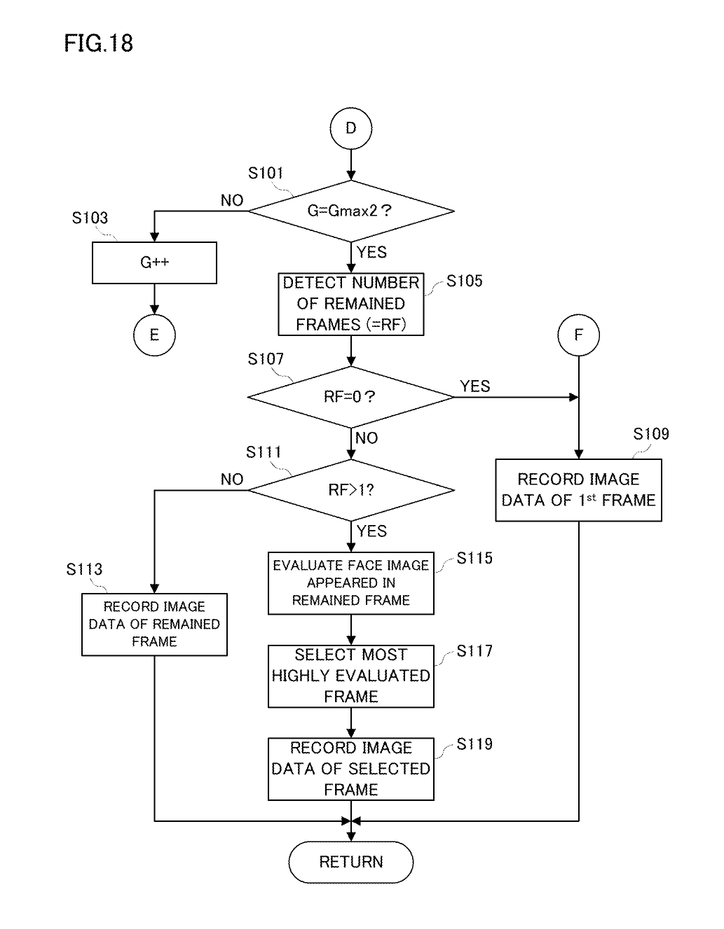

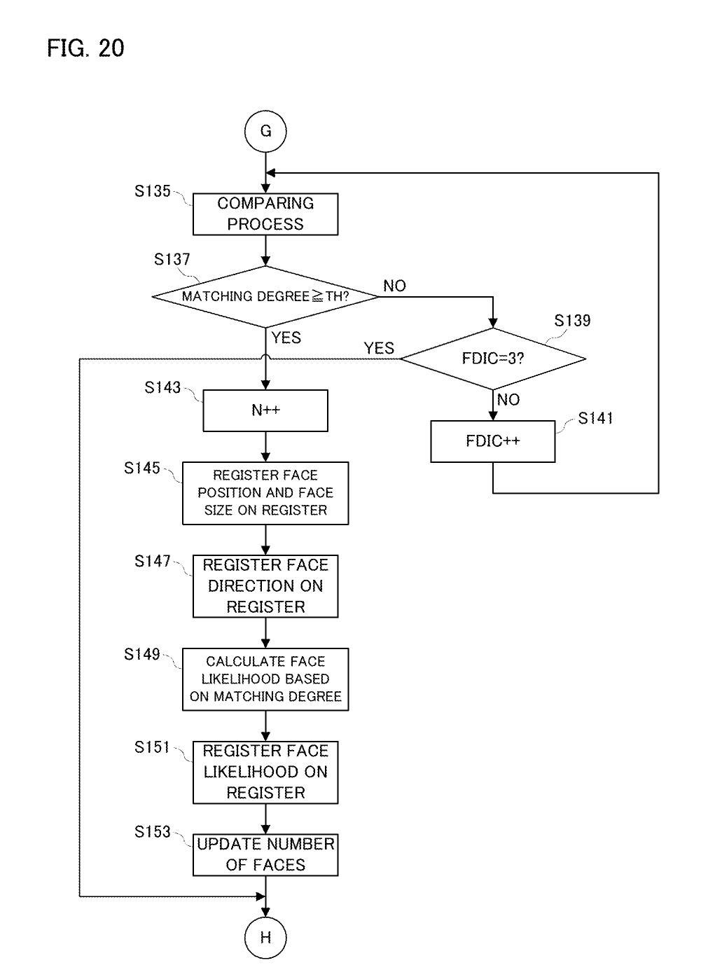

The CPU 26 executes, under a control of a multi task operating system, a plurality of tasks including the imaging task shown in FIG. 13 to FIG. 20, in a parallel manner. It is noted that, a control program corresponding to these tasks are stored in the flash memory 44.

With reference to FIG. 13, in a step S1, the moving-image taking process is executed. As a result, a live view image representing a scene is displayed on the LCD monitor 38. In a step S3, it is determined whether or not the shutter button 28sh is half depressed, and as long as a determined result is NO, the simple AE process is repeated in a step S5. As a result, a brightness of the live view image is adjusted roughly.

When the determined result of the step S3 is updated from NO to YES, in a step S7, the strict AE process is executed, and in a step S9, the AF process is executed. The brightness of the live view image is adjusted strictly by the strict AE process, and a sharpness of the live view image is improved by the AF process.

In a step S11, it is determined whether or not the shutter button 28sh is fully depressed, and in a step S13, it is determined whether or not the operation of the shutter button 28sh is cancelled. When YES is determined in the step S13, the process directly returns to the step S3, and when YES is determined in the step S11, the process returns to the step S3 via processes in a step S15 to S21.

In the step S15, it is determined whether or not the shooting mode at a current time point is any of the single shooting mode and the continuous shooting mode. When the shooting mode at the current time point is the single shooting mode, in the step S17, the still-image taking process is executed, and in the step S19, the recording process is executed. On the other hand, when the shooting mode at the current time point is the continuous shooting mode, in the step S21, the continuous shooting and recording process is executed. Upon completion of the process in the step S19 or S21, the process returns to the step S3.

As a result of the still-image taking process in the step S17, one frame of image data representing a scene at a time point at which the shutter button 28sh is fully depressed is evacuated from the YUV image area 32b to the recording image area 32c. Moreover, as a result of the recording process in the step S19, a corresponding command is applied to the memory I/F 40. The memory I/F 40 reads out the one frame of the image data evacuated to the recording image area 32c through the memory control circuit 30 so as to record the read-out image data in the file format on the recording medium 42.

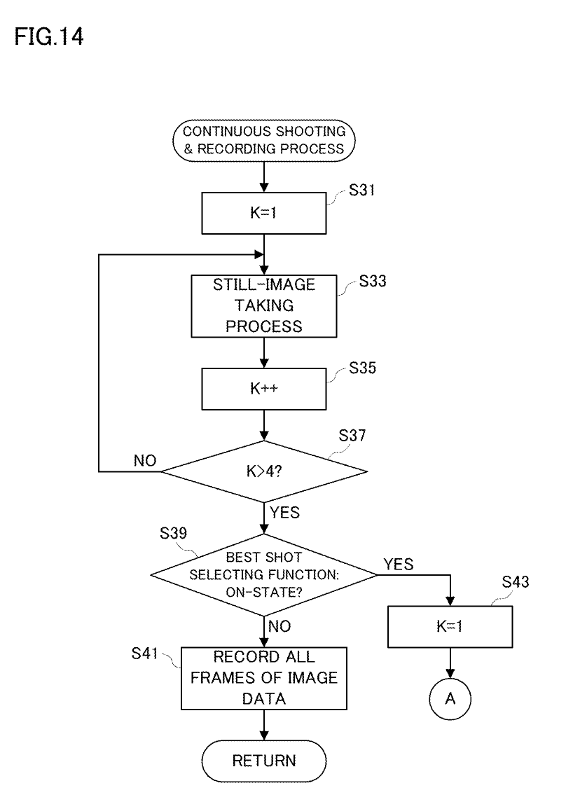

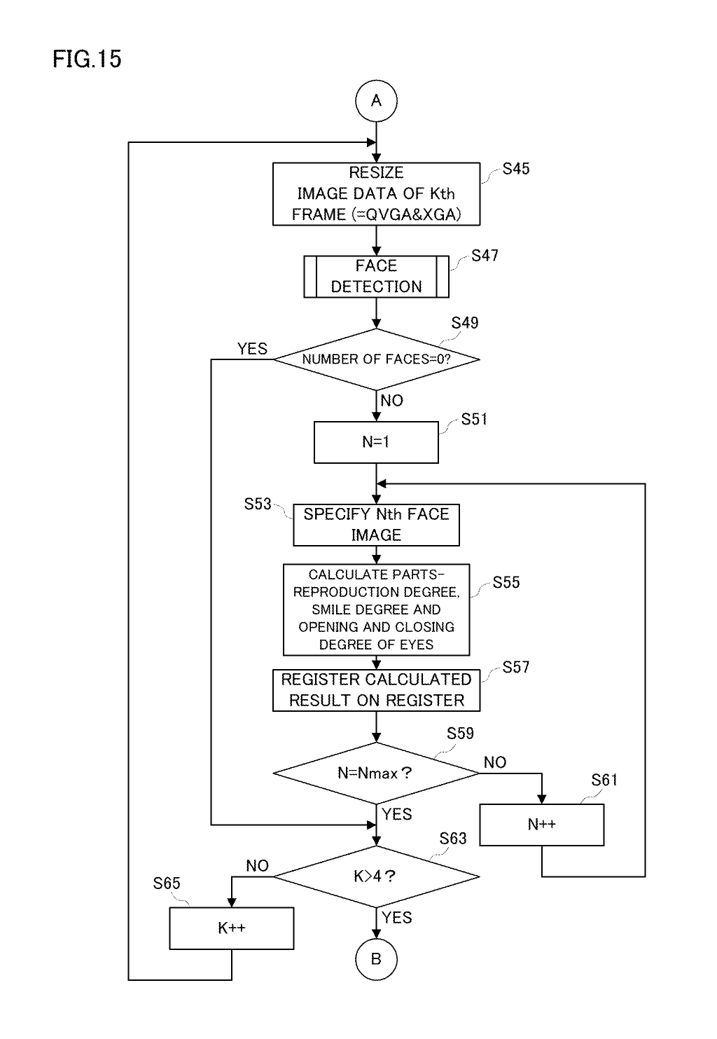

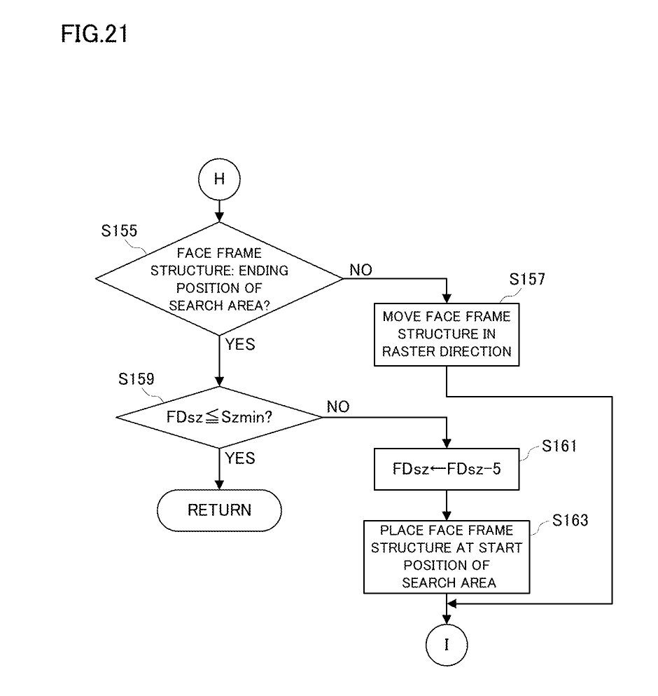

The continuous shooting and recording process in the step S21 is executed according to a subroutine shown in FIG. 14 to FIG. 21.

Firstly, in a step S31, the variable K equivalent to a frame number is set to “1”. In a step S33, the still-image taking process similarly to the above-described step S17 is executed after waiting for a generation of the vertical synchronization signal Vsync. In a step S35, the variable K is incremented, and in a step S37, it is determined whether or not the incremented variable K exceeds “4”. When a determined result is NO, the process returns to the step S33, and when the determined result is YES, the process advances to processes from a step S39. Thus, the still-image taking process in the step S33 is executed a total of four times in response to the vertical synchronization signal Vsync, and successive four frames of the image data are evacuated to the recording image area 32c.

In the step S39, it is determined whether or not the best shot selecting function is in an on-state. When a determined result is NO, the process advances to a step S41 so as to command the memory I/F 40 to record all frames of the image data evaluated in the recoding image area 32c. The memory I/F 40 reads out designated image data through the memory control circuit 30 so as to record the read-out image data in the file format on the recording medium 42. Upon completion of recording, the process returns to the routine in an upper hierarchy.

When the determined result of the step S39 is YES, in a step S43, the variable K is set to “1”, and in a step S45, the image data of the K-th frame is resized. Thereby, two frames of image data respectively having the QVGA resolution and the XGA resolution are additionally created corresponding to the K-th frame. In a step S47, the face detection process is performed on the QVGA resolution image data.

As a result of the face detection process, a face image coincident with any one of the three dictionary images contained in the face dictionary DC_F is searched from the image data to be noticed. When one or at least two face images are detected, a position and a size of each of the face images and a face direction and a face likelihood represented by each of the face images are registered in the K-th column of the register RGST1 as a part of face information. Furthermore, a total number of the detected face images is described in the K-th column of the register RGST1 as the number of the faces.

In a step S49, it is determined whether or not the number of the faces described in the K-th column is “0”. When a determined result is YES, the process advances to a step S63, and when the determined result is NO, the process advances to the step S63 via steps S51 to S61.

In the step S51, the variable N equivalent to a face number is set to “1”, and in the step S53, the N-th face image appeared in the K-th frame is specified. With reference to the position and size of the face image described corresponding to the variable N in the K-th column of the register RGST1, the desired face image is specified on the XGA resolution image data corresponding to the K-th frame.

In the step S55, a reproduction degree forming parts of the specified face image (parts: eye, nose and mouth), a smile degree of the specified face image and an opening and closing degree of the eyes on the specified face image are calculated. In the step S57, the calculated parts-reproduction degree, smile degree and opening and closing degree are registered in the K-th column of the register RGST1 corresponding to the variable N. In the step S59, it is determined whether or not the variable N has reached “Nmax” (=the number of the faces described in the K-th column of the register RGST1). When a determined result is NO, in the step S61, the variable N is incremented, and thereafter, the process returns to the step S53. On the other hand, when the determined result is YES, the process advances to the step S63.

In the step S63, it is determined whether or not the variable K exceeds “4”. When a determined result is NO, the variable K is incremented in a step S65, and thereafter, the process returns to the step S45. On the other hand, when the determined result is YES, the process advances to a step S67.

In the step S67, with reference to the size and position of the face image described in the register RGST1, the face images appeared in four frames of the image data to be noticed are converted into a group for each common face. As a result, one or at least two groups each of which is formed of equal to or less than four face images are constructed. The face number identifying the face image in each constructed group is described in the register RGST2.

In a step S69, the group in which the number of the belonging face images falls below “4” is searched from among one or at least two groups constructed in the step S67. In a step S71, it is determined whether or not the desired group is discovered by the searching process, and when a determined result is NO, the process directly advances to a step S85 whereas when the determined result is YES, the process advances to the step S85 via processes in steps S73 to S83.

In the step S73, the variable G equivalent to a group number is set to “1”. In the step S75, the G-th group is noticed out of one or at least two groups discovered in the step S69, and one or at least two parts-reproduction degrees respectively corresponding to one or least two face images belonging to the G-th group are read out from the register RGST1 so as to calculate the average value of the read-out one or at least two parts-reproduction degrees.

In a step S77, it is determined whether or not the calculated average value exceeds the reference value REF1 (whether or not the G-th group is constructed by an erroneous detection of the face image), and when a determined result is NO, the process advances to the step S81 whereas when the determined result is YES, the process advances to the step S81 after deleting the G-th group registered in the register RGST2.

In the step S81, it is determined whether or not the variable G has reached the maximum value Gmax1 (=a total number of the groups discovered by the process in the step S69), and when a determined result is NO, the process returns to the step S75 after the variable G is incremented in the step S83 whereas when the determined result is YES, the process advances to the step S85. In the step S85, it is determined whether or not the register RGST2 is cleared by the process in the step S79, and when a determined result is YES, the process advances to a step S109 whereas when the determined result is NO, the process advances to a step S87.

In the step S87, the variable G is set to “1” again, and in a step S89, a frame in which the face image belonging to the G-th group has appeared is specified from among the four frames to be noticed. In a step S91, it is determined whether or not there is a frame which is not specified by the process in the step S89, i.e., the missing frame. When a determined result is NO, the process advances to a step S95 whereas when the determined result is YES, the process advances to a step S93. In the step S93, a registration related to the missing frame is deleted or excluded from the register RGST2, and thereafter, the process advances to the step S95.

In the step S95, the face image in which the parts-reproduction degree falls below the reference value REF2 (REF2>REF1) is searched from the G-th group, and in a step S97, it is determined whether or not the desired face image has been discovered by the searching process. When a determined result is NO, the process advances to a step S101 whereas when the determined result is YES, the process advances to a step S99. In the step S99, a registration related to the frame in which the discovered face image has appeared is deleted or excluded from the register RGST2, and thereafter, the process advances to the step S101.

In the step S101, it is determined whether or not the variable G has reached the maximum value Gmax2 (Gmax2: a total number of the groups registered in the register RGST2), and when a determined result is NO, the process returns to the step S89 after the variable G is incremented in a step S103 whereas when the determined result is YES, the process advances to a step S105. In the step S105, the number of the remaining frames (frames remained in the register RGST2 after the process in the step S93 and/or S99) is detected as the number of remaining frames RF.

In steps S107 and S111, a value of the detected number of remaining frames RF is determined. When the number of the remaining frames RF is “0”, the process returns to the routine in an upper hierarchy via the process in the step S109, when the number of the remaining frames RF is “1”, the process returns to the routine in an upper hierarchy via a process in a step S113, and when the number of the remaining frames RF exceeds “1”, the process returns to the routine in an upper hierarchy via processes in steps S115 to S119.

In the step S109, the memory I/F 40 is commanded to execute the recording process on the image data of the first frame out of the four frames to be noticed. Moreover, in the step S113, the memory I/F 40 is commanded to execute the recording process on the image data of the remaining frames. The memory I/F 40 reads out the designated image data from the recording image area 32c through the memory control circuit 30 so as to record the read-out image data in the file format on the recording medium 42.

In a step S115, qualities of one or at least two face images appeared in the remaining frames are evaluated for each frame. Upon evaluation, the face direction, the face likelihood, the smile degree and the opening and closing degree of the eyes described in the register RGST1 are referred to. In the step S117, a single frame which is most highly evaluated is selected from among the remaining frames, and in the step S119, the memory I/F 40 is commanded to execute the recording process on the image data of the selected frame.

Similarly to the above-described case, the memory I/F 40 reads out the designated image data from the recording image area 32c through the memory control circuit 30 so as to record the read-out image data in the file format on the recording medium 42.

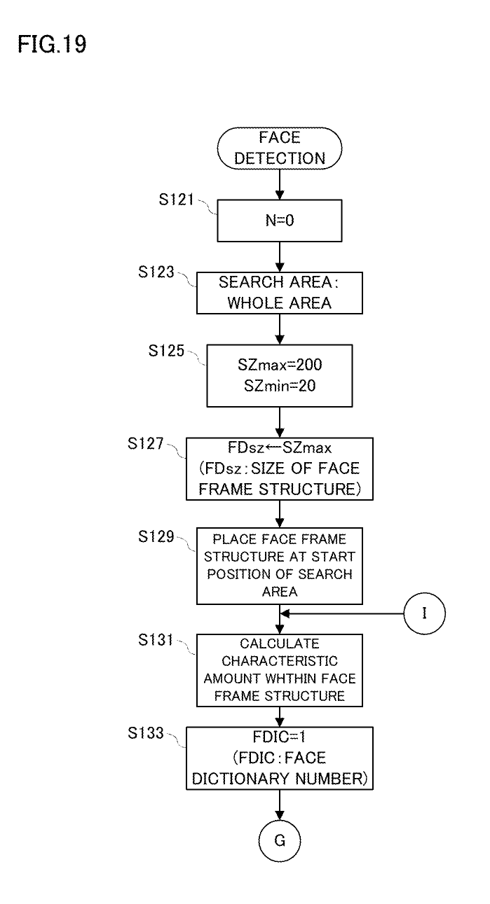

The face detection process in the step S47 shown in FIG. 15 is executed according to a subroutine shown in FIG. 19 to FIG. 21.

Firstly, in a step S121, the variable N is set to “0”, and in a step S123, the whole evaluation area EVA is set as the search area. In a step S125, in order to define a variable range of a size of the face frame structure FD, the maximum size SZmax is set to “200”, and the minimum size SZmin is set to “20”. Upon completion of defining the variable range, the process advances to a step S127 so as to set the size of the face frame structure FD to “SZmax”.

In a step S129, the face frame structure FD is placed at a start position (an upper left position) of the search area. In a step S131, a part of the image data belonging to the face frame structure FD is extracted from the image data of the K-th frame having the QVGA resolution so as to calculate a characteristic amount of the extracted image data. In a step S133, the face dictionary number FDIC is set to “1”.

In a step S135, the characteristic amount calculated in the step S131 is compared with a characteristic amount of a dictionary image corresponding to the face dictionary number FDIC out of the three dictionary images contained in the face dictionary DC_F. In a step S137, it is determined whether or not a matching degree calculated by the comparing process exceeds the threshold value TH, and in a step S139, it is determined whether or not the face dictionary number FDIC is “3”.

When a determined result of the step S139 is NO, the face dictionary number FDIC is incremented in a step S141, and thereafter, the process returns to the step S135. When a determined result of the step S137 is NO and a determined result of the step S139 is YES, the process directly advances to a step S155. When YES is determined in the step S137, the process advances to the step S155 via processes in steps S143 to S153.

In the step S143, the variable N is incremented, and in the step S145, a position and a size of the face frame structure FD at a current time point are registered in the K-th column of the register RGST1 corresponding to the variable N. In the step S147, a face direction allocated to the face dictionary number FDIC at a current time point is detected from the face dictionary DC_F so as to register the detected face direction in the K-th column of the register RGST1 corresponding to the variable N.

In the step S149, the face likelihood of the image data belonging to the face frame structure FD is calculated based on the matching degree calculated by the comparing process in the step S135. In the step S151, the calculated face likelihood is registered in the K-th column of the register RGST1 corresponding to the variable N. In the step S153, the number of the faces described in the K-th large column of the register RGST1 is incremented.

In the step S155, it is determined whether or not the face frame structure FD has reached an ending position (a lower right position) of the search area. When a determined result is NO, in a step S157, the face frame structure FD is moved by a predetermined amount in a raster direction, and thereafter, the process returns to the step S131. When the determined result is YES, in a step S159, it is determined whether or not the size of the face frame structure FD is equal to or less than “SZmin”. When a determined result is NO, the size of the face frame structure FD is reduced by a scale of “5” in a step S161, the face frame structure FD is placed at the start position (the upper left position) of the search area in a step S163, and thereafter, the process returns to the step S131. When the determined result of the step S159 is YES, the process returns to the routine in an upper hierarchy.

As can be seen from the above-described explanation, the CPU 26 detects one or at least two face images each of which is coincident with the dictionary image from each of K frames of the image data accommodated in the recording image area 32c of the SDRAM 32 (S47), and executes on the same K frames of image data a process of classifying the detected face images according to a common face (S67). Moreover, the CPU 26 determines an attribute of equal to or less than K of face images belonging to each of one or at least two groups constructed by the classification process (S87 to S89, S95, S101 to S103), and excludes image data of a frame satisfying the error condition out of the K frames of the image data (S91 to S93, S97 to S99). The CPU 26 selects any one of the frames remained after the exclusion process for recording (S111 to S119).

When the posture of the face is varied in a process of the continuous shooting, the number of the face images forming the group varies in the range of equal to or less than K. Thus, by noticing the attribute of the equal to or less than K of the face images belonging to each group, it becomes possible to comprehend a quality of the face image appeared in each of the K frames of the image data, and furthermore, it becomes possible to exclude image data in which a low-quality face image is appeared. Image data to be recorded is selected from among one or at least two frames of the image data remained after thus excluded. Thereby, an image selecting performance is improved.

It is noted that, in this embodiment, any one of the one or at least two frames of the image data remained after the excluding process is selected for record them, however, a plurality of frames may be selected to record them.

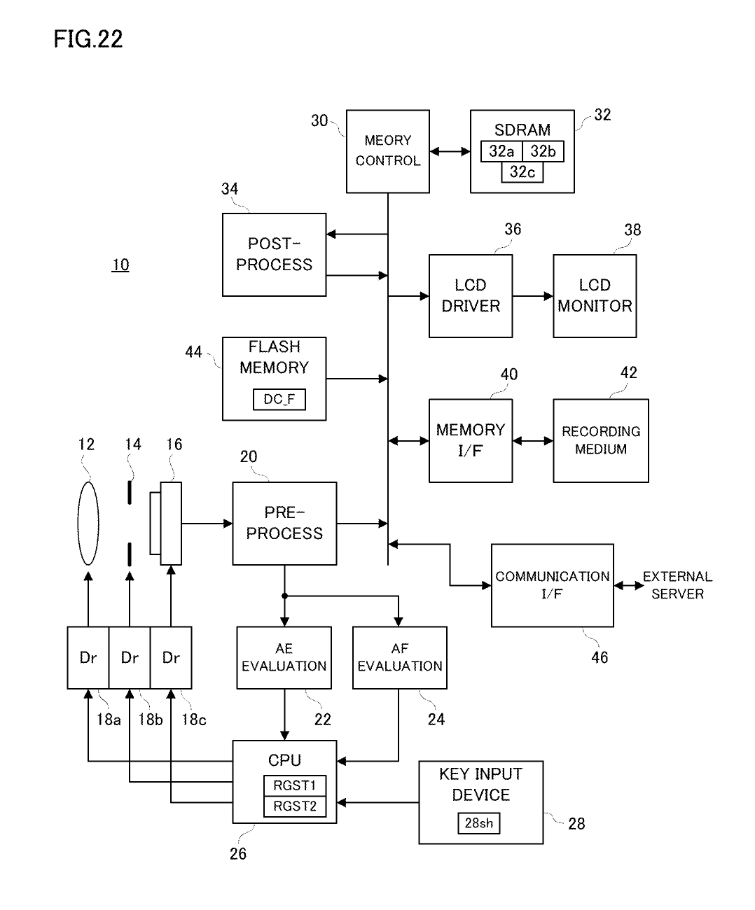

Moreover, in this embodiment, the control programs equivalent to the multi task operating system and the plurality of tasks executed thereby are previously stored in the flash memory 11. However, a communication I/F 46 may be arranged in the digital camera 10 as shown in FIG. 22 so as to initially prepare a part of the control programs in the flash memory 44 as an internal control program whereas acquire another part of the control programs from an external server as an external control program. In this case, the above-described procedures are realized in cooperation with the internal control program and the external control program.

Moreover, in this embodiment, the processes executed by the CPU 26 are divided into a plurality of tasks as described above. However, each of tasks may be further divided into a plurality of small tasks, and furthermore, a part of the divided plurality of small tasks may be integrated into another task. Moreover, when each of tasks is divided into the plurality of small tasks, the whole task or a part of the task may be acquired from the external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus, comprising:
a detector which detects one or at least two object images each of which is coincident with a dictionary image from each of K (K: an integer of two or more) of continuous shot images;
a classifier which executes on the K of continuous shot images a process of classifying the object images detected by said detector according to a common object;
a determiner which determines an attribute of equal to or less than K of object images belonging to each of one or at least two object image groups classified by said classifier;
a first excluder which excludes a continuous shot image satisfying an error condition out of the K of the continuous shot images, based on a determined result of said determiner; and
a selector which selects a part of one or at least two continuous shot images remained after an exclusion of said first excluder as a specific image.

2. An image processing apparatus according to claim 1, further comprising:
a creator which creates a parameter defining a quality of the object image detected by said detector;
a searcher which executes a process of searching for an object image group formed of an object image representing an object different from a desired object, from the one or at least two object image groups classified by said classifier, based on the parameter created by said creator; and
a second excluder which excludes the object image group discovered by said searcher from a target to be determined by said determiner.

3. An image processing apparatus according to claim 2, wherein the parameter created by said creator includes a reproduction degree of an element forming the desired object, and the object image group searched for by said searcher is equivalent to an object image group formed of an object image in which a value of the parameter falls below a reference.

4. An image processing apparatus according to claim 3, wherein the desired object is equivalent to a face portion of a person.

5. An image processing apparatus according to claim 1, wherein said classifier executes a classification based on positions of the object images detected by said detector.

6. An image processing apparatus according to claim 1, wherein the attribute noticed by said determiner includes identification information of equal to or less than K of the continuous shot images in which the equal to or less than K of the object images respectively appeared, and the continuous shot image satisfying the error condition is equivalent to a continuous shot image different from the equal to or less than K of the continuous shot images in which the equal to or less than K of the object images respectively appeared.

7. An image processing apparatus according to claim 1, wherein the attribute noticed by said determiner includes a reproduction degree of each of the equal to or less than K of the object images, and the continuous shot image satisfying the error condition is equivalent to a continuous shot image having an object image in which the reproduction degree falls below the reference.

8. A computer program embodied in a tangible medium, which is executed by a processor of an image processing apparatus, said program comprising:
a detecting step of detecting one or at least two object images each of which is coincident with a dictionary image from each of K (K: an integer of two or more) of continuous shot images;
a classifying step of executing on the K of continuous shot images a process of classifying the object images detected by said detecting step according to a common object;
a determining step of determining an attribute of equal to or less than K of object images belonging to each of one or at least two object image groups classified by said classifying step;
a first excluding step of excluding a continuous shot image satisfying an error condition out of the K of the continuous shot images, based on a determined result of said determining step; and
a selecting step of selecting a part of one or at least two continuous shot images remained after an exclusion of said first excluding step as a specific image.

9. An image processing method executed by an image processing apparatus, comprising:
a detecting step of detecting one or at least two object images each of which is coincident with a dictionary image from each of K (K: an integer of two or more) of continuous shot images;
a classifying step of executing on the K of continuous shot images a process of classifying the object images detected by said detecting step according to a common object;
a determining step of determining an attribute of equal to or less than K of object images belonging to each of one or at least two object image groups classified by said classifying step;
a first excluding step of excluding a continuous shot image satisfying an error condition out of the K of the continuous shot images, based on a determined result of said determining step; and
a selecting step of selecting a part of one or at least two continuous shot images remained after an exclusion of said first excluding step as a specific image.
